(19) United States
(12) Patent Application Publication
(10) Pub. No.: US 2026/0225221 A1
(43) Pub. Date: Aug. 6, 2026

(54) HAND GRIP APPARATUS FOR MOVING INDUSTRIAL APPARATUS

(71) Applicant: ITIP HANDLES LIMITED, Wokingham (GB)

(72) Inventor: Simon ALLDER, Wokingham (GB)

(73) Assignee: ITIP HANDLES LIMITED, Wokingham (GB)

(21) Appl. No.: 19/150,792

(22) PCT Filed: Jan. 24, 2024
(86) PCT No.: PCT/GB2024/050190

§ 371 Date: Jul. 24, 2025

(30) Foreign Application Priority Data
Jan. 24, 2023 (GB) 2301038.2
Apr. 24, 2023 (GB) 2305933.0
Jun. 5, 2023 (GB) 2308333.0

(51) Int. Cl. B25G 3/38; F16B 2/10

(52) U.S. Cl. CPC B25G 3/38; F16B 2/10

(57) ABSTRACT

Hand grip apparatus for a frame of apparatus such as a roll cage or bun crates. The hand grip apparatus has a handle portion and first and second connectors. The first connector is connected at one end to the handle, and is tubular to so receive the second connector therein allowing for linear and rotational movement of the first connector in respect of the second connector. The second connector has two arms pivotally connected at their ends proximal to the first connector. The relative positions of the first and second connectors are movable between a first position whereby the ends of the arms, distal to the pivotal connection, are separable to secure around the framework, and a position whereby the distal ends of the arms are closed and secured together to grip the framework.

### FIELD OF INVENTION

This invention relates to hand grip apparatus and, more especially, this invention relates to hand grip apparatus for use in steering industrial equipment, such as for example a roll cage.

### BACKGROUND TO THE INVENTION

Roll cages are well known for transporting products, for example around a warehouse or from a delivery vehicle to a supermarket or other type of shop. Each roll cage typically comprises an open mesh body section for receiving a large amount of products to be sold, and wheel means by which the roll cages are pushed or pulled. The wheel means are usually wheels, with there being two fixed wheels at one end of the roll cage and two swivel wheels at the other end of the roll cage. The swivel wheels swivel 360°and they enable direction to be imparted to the roll cage when the roll cage is being pushed or pulled. The roll cage should be pushed or pulled with the fixed wheels leading and the swivel wheels following. The swivel wheels are then able to provide rear steering. Often though, the roll cage is pushed or pulled incorrectly so that the swivel wheels are leading rather than following. In this case, the swivel wheels have a tendency to swivel unexpectedly and this may cause the roll cage to tip over. This is especially so if the roll cage is being manoeuvered onto a tail lift of a truck, or if the roll cage strikes a step between floor levels or strikes debris. The tipping over the roll cage may cause damage to the goods being transported in the roll cage. The damage may be in the form of broken goods and/or soiled goods. The fixed and swivel wheels may be in the form of casters.

A further problem is that the roll cages themselves often cause injury to users pushing or pulling the roll cages due to the users doing the pushing and pulling with their fingers placed through the mesh of the roll cages. If a roll cage suddenly tips over, a user may get their fingers trapped and injured.

A yet further problem is that there is no particular position at which the roll cages should be pushed or pulled. Some users will push or pull a roll cage at a position which is higher up than other users. If the roll cage is pushed or pulled at a position which is too high up with respect to the centre of gravity of the roll cage, then this may cause an extra instability factor during pushing or pulling of the roll cage.

A hand grip apparatus suitable for a roll cage having cylindrical frame sections has been developed by the applicant and is the subject of the applicant's earlier patent application WO 2021/160983, which is also incorporated by reference. Whilst the hand grip has proven to be successful, the assembly requires a short length of box section to be permanently welded or clamped to the framework as any protruding addition, such as a handle will hinder the collapsing and nesting of empty cages that need to be returned.

The present invention seeks to provide adapted grip handle which does not require connection to mounted box section, and which can be used with roll cages with square cross-sectional frameworks.

There is also a need to transport crates or carriers which are stacked when empty. Bun crates, for example, are used widely in industry to carry food products from place to place. Conventionally, stacked crates are placed on a wheeled base crate for transportation. The present invention also seeks to provide hand grip apparatus that can be used to grip the stack of crates allowing control of movement and steering of the wheeled base crate when loaded with stacks of crates to be transported from place to place.

### STATEMENT OF INVENTION

Accordingly, there is provided a hand grip apparatus for a frame of apparatus in use, the hand grip apparatus comprising a handle portion and first and second connectors, the first connector being connected at one end to the handle, and being tubular to so receive the second connector therein allowing for linear and rotational movement of the first connector in respect of the second connector, wherein the second connector comprises two arms pivotally connected at their ends proximal to the first connector, and wherein the relative positions of the first and second connectors being movable between a first position whereby the ends of the arms, distal to the pivotal connection, are separable to secure around the framework, and a position whereby the distal ends of the arms are closed and secured together to grip the framework.

The frame may take the form of horizontal and/or vertical members of a cage, such as a roll cage for example, or the framework may be the horizontal and/or vertical struts or members that form the structure of a carrier such as bun crate, for example.

### BRIEF DESCRIPTION OF DRAWINGS

At least one embodiment of the invention will now be described with reference to the accompanying figures in which:

FIG. 1 shows a hand grip assembly in accordance with the invention being connected to a roll cage frame, during use;

FIG. 2 shows a hand grip assembly of FIG. 1 connected to a roll cage frame;

FIG. 3 shows a hand grip assembly of FIG. 2 in a locked position;

FIG. 4 shows the arms of the second connector of the assembly from one side;

FIG. 5 shows the arms of the second connector of the assembly from the other side;

FIG. 6 shows the inner surface of the arms of the second connector;

FIG. 7 shows the outer surface of the arms of the second connector;

FIG. 8 shows the hand grip assembly used for gripping the frames of two bun crates within a stack;

FIG. 9 shows a hand grip assembly with an alternative profile;

FIG. 10 shows a plan view of the hand grip assembly of FIG. 9;

FIG. 11 shows the hand grip assembly of FIG. 8 open in use; and

FIGS. 12 and 13 show the hand grip of FIG. 9 in use.

### DETAILED DESCRIPTION OF THE INVENTION

A hand grip assembly of the present invention generally comprises a handle 2, a first connector 4 secured to the handle 2 and extending outwardly therefrom, and a second connector 6 to be received in the first connector 4.

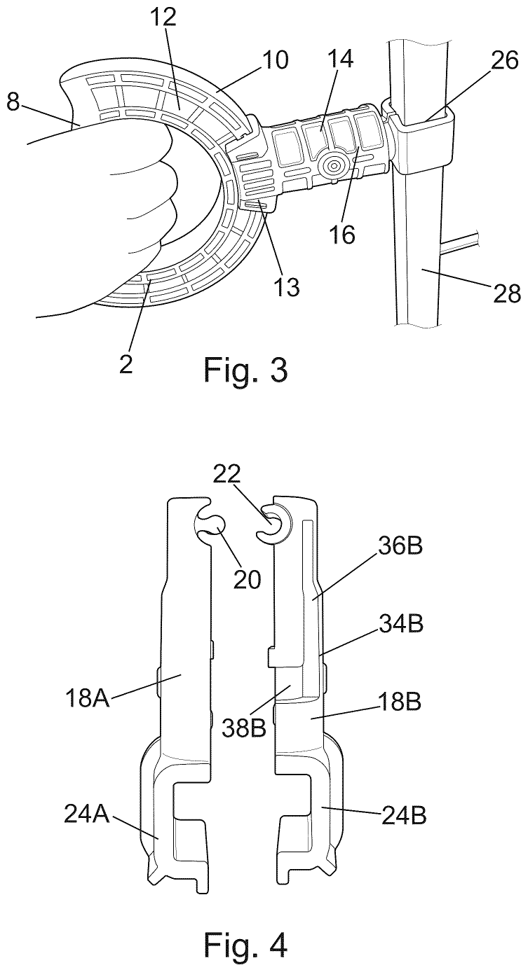

As can be seen best in FIG. 3, the handle 2 is generally D-shaped with the generally straight section forming a hand grip 8. The curved section 10 of the handle 2 is formed with arcuate recesses 12 on each side.

The handle 2 may be constructed with additional features of the handle disclosed in the applicants earlier patent, referred to in the background.

The first connector 4 is secured to the curved section 10 of the handle 2. One securing end of the connector 4 is formed with two divided arms that form a clip 13 which clips into the arcuate recesses 12 of the curved section 10 of the handle 2 in a selected position. Preferably, as shown, the first connector 4 is secured to the handle 2 so to extend generally perpendicular in the same plane.

The first connector 4 has a tubular main body 14 with a generally cylindrical cross-section. Concentric ribs 16 are provided on the outer surface of the connector body 14 for torsional strength.

A second connector 6 is received within the open end of the first connector to be slidable therein.

The second connector 6 comprises two elongate arms 18 pivotally connected at one end.

Side views of the (disconnected) 18 arms are shown in FIGS. 3 and 4. A first arm 18A has a laterally extending elongate male connector part 20 formed at one end to be received in a female connector part formed as a complimentary-shaped laterally extending elongate recess 22 in the respective end of the second arm 18B.

The male/female connector parts have arcuate structures and provide a pivotal connection at one end of the two arms 18. Other pivotal connection mechanisms may be employed.

The ends of each arm 18 distal to their connection are formed as a semi-square 24 such that a closable square recess 26 is formed when the arms 18 are held together. This allows the ends of the arms 18 to grip around a square-cross section frame 28, such as one utilised on a roll cage, for example.

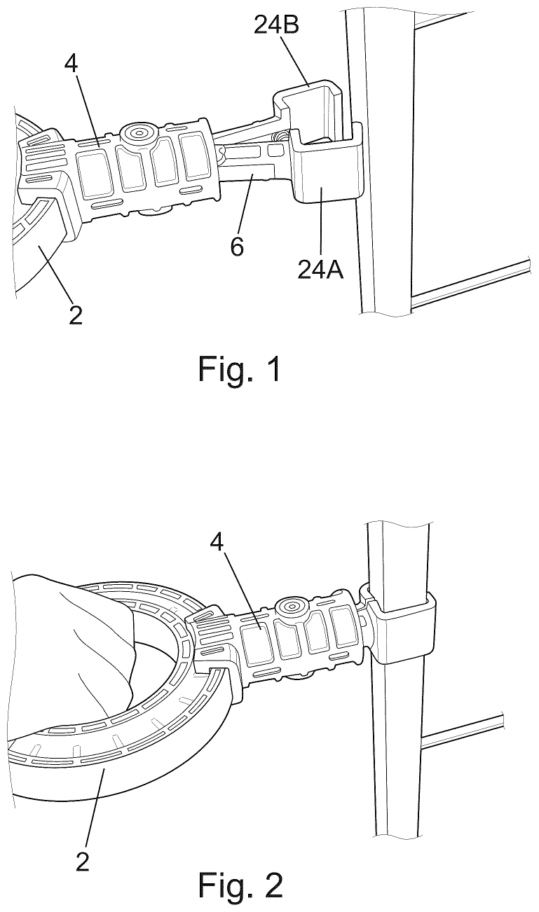

As can be seen in FIG. 6, the internal surface 30 of each arm 18 has a circular recess 32 to receive a retain a spring element (not shown) laterally between the arms 18 so to bias the distal ends of the arms 18, and thus the semi-square grip ends 24, away from each other, in an orientation shown in FIG. 1.

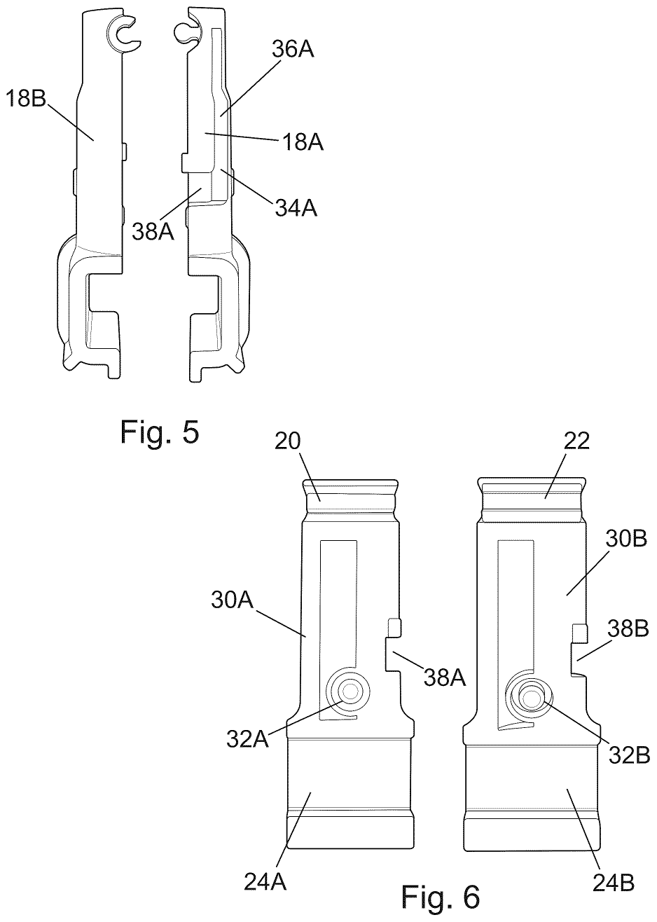

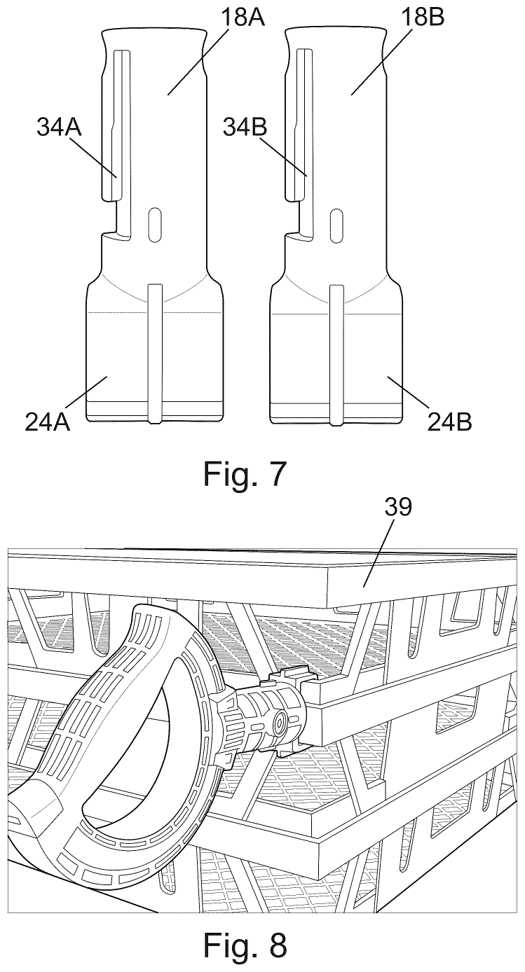

Returning to FIGS. 4 and 5, each arm 18 has an L-shaped locking groove 34 extending longitudinally along part of the length to provide a movement and locking mechanism of the second connector 6 in respect of the first connector 4.

Each locking groove 34 receives a locking member (not shown) extending from or through the walls of the main body 14 into the first connector 4.

When the handle 2 is in, or rotated to, a first position, being a generally horizontal orientation as shown in FIGS. 1 and 2, the locking member is located within the longitudinally extending section 36 of the groove 34. This allows linear movement of the second connector 6 within the first connector 4 as the locking member slides along that section 36 of the groove 34.

Linear movement of the second connector 6 towards the handle 2 causes the first connector 4 to act against the spring and close the arms 18 of the second connector 6 together securing them around the frame 28, as can be seen in FIG. 2.

Once in place, and the locking member is located at the end of the longitudinally extending section 36 of the groove 34, rotation of the handle 26 to a generally vertical orientation, causes the locking member to locate within the laterally extending section 38 of the groove 24 at which point any further linear movement of the second member 6 in respect of the first member 4, in either direction, is prevented.

At this time, the handle 2 is locked in place, secured to the frame 28, as shown in FIG. 3.

The fact each arm 18 has a locking groove 34 to receive a locking member, the and the grooves 34 are aligned in reciprocal formation ensures to a locking force is applied to both arms 18 from opposing directions to strengthen the connector 6 and prevent it being weakened when a torsional or impact force is applied to one side.

To release the handle 2 from the frame 28, the handle 2 is simply rotated back to the horizontally orientated position once again to locate the locking member back into the longitudinally extending section 36 of groove 34 to allow linear movement of the second connector 6 with respect to the first connector 4 thereby to release the arms 18 and open the square recess 26 to disconnect second connector 6 from the frame 28.

The end grips formed by the arms 18 of the second connector 6 may form other shapes than semi-square, to allow the apparatus to be used on different cross-sectional shape frameworks. They may be semi-circular, for example. The orientation of the locking member and/or grooves 34 may be different to provide different direction or angles of rotation for locking and unlocking the hand grip apparatus to and from the frame 28.

FIG. 8 shows the hand grip assembly being used to grip frames bun crates or carriers 39 that have been stacked up to be pushed on a wheeled crate. The end grips formed by the arms 18 secure around the top (horizontal) frame of one bun crate and the base frame of bun crate below it to hold them together and form a grip around the entire stack.

The stack remains stable due to the bun crates being stacked within each other. Preferably a hand grip assembly is secured at each end to ensure control of the wheeled crate as it is pulled.

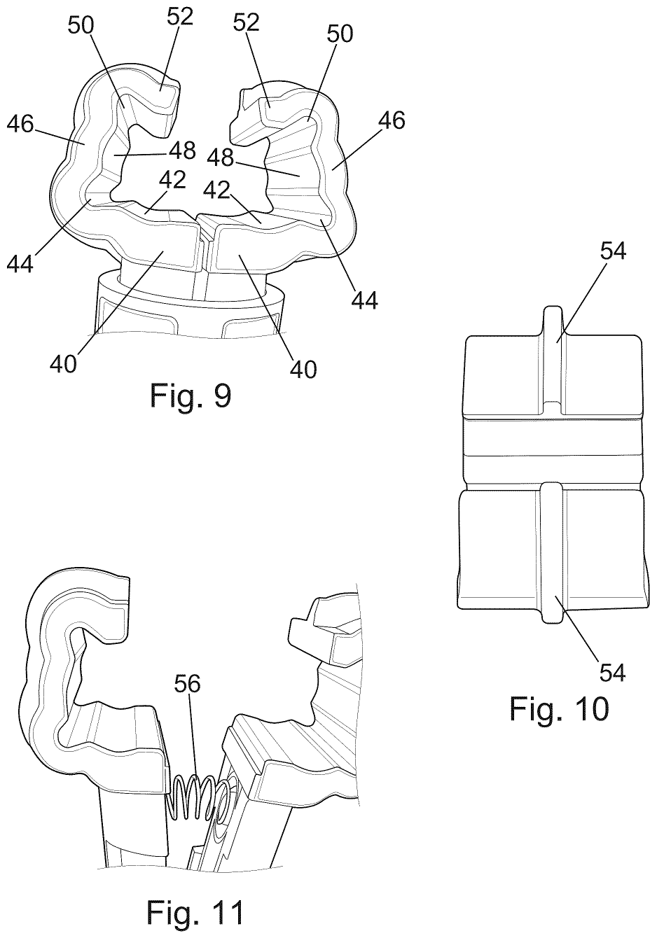

FIGS. 9 to 13 show an alternative embodiment of the invention. The features of the first embodiment are the same except the profile of the distal end of the second connector. Instead of the distal end of each arm having the profile of a semi-square, the distal end of each arm 18 is formed with curvatures that form, when closed together, a generally figure of eight shaped profile.

Specifically, the distal ends of each arm 18 have a perpendicularly extending base 40 with a slightly concave recess 42 on the inside surface. The base 40 leads to a part-circular corner recess 44, in turn leading to a side section 46 with a concave recess 48 on the inside surface, in turn leading to a second part-circular corner recess 50 finally leading to a top section 52.

A strengthening rib 54 is provided along the outside surface of the distal end of each arm.

FIG. 11 shows the arms separated with the spring element 56 extending laterally between the arms to bias the jaws away from each other.

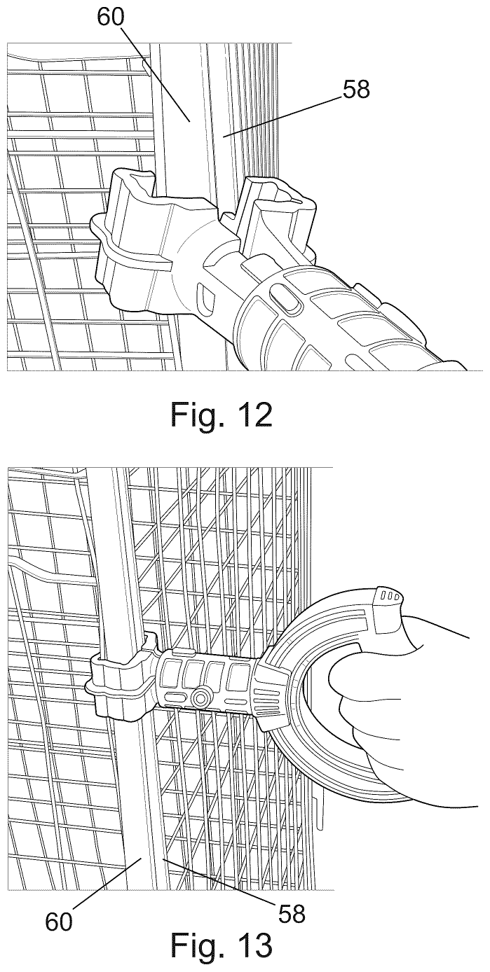

As can be seen from FIGS. 12 and 13, the shaped profile of the second connector of this embodiment allows the connector to clamp around two cylindrical frame sections of a roll cage, for example, the door frame 58 and the side panel 60 of the roll cage, when the door of the roll cage is closed, and the frames of the door and side panel are adjacent one another.

Similarly, the connector can clamp to the roll cage when the door of the roll cage is fully swung open the back edge of the door is contiguous with the side panel of the roll cage.

Consequently, the hand grip connector can be equally used for roll cages with cylindrical frames.

The connector is secured and released in the same way has been described in relation to the first embodiment.

The grip profile of the embodiment of FIGS. 9 to 13 may be selected to grip stacked crates, as for example the embodiment of FIG. 8, if the crate frames are cylindrical or rod shaped rather than planar.

1. A hand grip apparatus for a frame of apparatus in use, the hand grip apparatus comprising a handle portion and first and second connectors, the first connector being connected at one end to the handle, and being tubular to so receive the second connector therein allowing for linear and rotational movement of the first connector in respect of the second connector, wherein the second connector comprises two arms pivotally connected at their ends proximal to the first connector, and wherein the relative positions of the first and second connectors being movable between a first position whereby the ends of the arms, distal to the pivotal connection, are separable to secure around the framework, and a position whereby the distal ends of the arms are closed and secured together to grip the framework.

2. The hand grip apparatus according to claim 1, wherein the end of each arm distal to the pivotal connection has the general form of a semi-square such that a closable square recess is formed when said ends are closed together.

3. The hand grip apparatus according to claim 1, wherein the end of each arm distal to the pivotal connection has the general form of a semi-circle such that a closable circular recess is formed when said ends are closed together.

4. The hand grip apparatus according to claim 1, wherein the end of each arm distal to the pivotal connection is formed with curvatures such that a closable figure of eight recess is formed when said ends are closed together.

5. The hand grip apparatus according to claim 1, wherein a spring element extends laterally between the arms to bias the distal ends of the arms away from each other.

6. The hand grip apparatus according to claim 5, wherein each end of the spring element is located and retained in a circular recess formed on each arm.

7. The hand grip apparatus according to claim 6, wherein linear movement of the second connector towards the handle causes the first connector to act against the spring element to close the distal ends of the arms together.

8. The hand grip apparatus according to claim 1, wherein each arm has an L-shaped locking groove extending longitudinally along part of its length.

9. The hand grip apparatus according to claim 8, wherein the first connector includes a locking member received in use within the groove to be slidable there along.

10. The hand grip apparatus according to claim 9, wherein rotation of the handle from a first position to a second position causes the locking member to be received within a longitudinal section of the groove and a lateral section of the grove respectively.

11. The hand grip apparatus according to claim 1, wherein the handle is generally D-shaped with the straight section forming the hand grip.

12. The hand grip apparatus according to claim 11, wherein the curved section of the handle is formed with arcuate recesses on each side.

13. The hand grip apparatus according to claim 11, wherein the first connector is secured to the curved section of the handle.
